(19) United States
(12) Patent Application Publication
(10) Pub. No.: US 2025/0150018 A1
(43) Pub. Date: May 8, 2025

(54) METHOD AND SYSTEM FOR CONTROLLING TEMPERATURE OF MOTOR, AND STORAGE MEDIUM

(71) Applicant: AAC Acoustic Technologies (Shanghai) Co., Ltd., Shanghai (CN)

(72) Inventors: Xin Guo, Shanghai (CN); Yajun Zheng, Shanghai (CN); Shuhan Yao, Shanghai (CN)

(21) Appl. No.: 18/629,973

(22) Filed: Apr. 9, 2024

Related U.S. Application Data
(63) Continuation of application No. PCT/CN2023/129939, filed on Nov. 6, 2023.

(51) Int. Cl. H02P 29/60

(52) U.S. Cl. CPC H02P 29/60

(57) ABSTRACT

A method and a system for controlling temperature of a motor, and a storage medium are provided. The method includes: acquiring a real-time temperature of the motor; comparing the real-time temperature with multiple preset temperature thresholds corresponding to a multi-level voltage amplitude limiting strategy; and determining the voltage amplitude limiting strategy at a level corresponding to the real-time temperature according to the comparison result and limiting input voltage of the motor with the voltage amplitude limiting strategy at the corresponding level to control the temperature of the motor. Through the multi-level temperature protection solution, when the motor reaches the corresponding temperature threshold, the corresponding limiting strategy comes into effect. Therefore, the system can maintain better performance while limiting the operating temperature for stable operation. Further, the real-time temperature of the system can be effectively controlled, thereby improving user safety and extending the service life of hardware.

### CROSS REFERENCE TO RELATED APPLICATIONS

The present application a continuation of PCT Patent Application No. PCT/CN2023/129939 entitled “METHOD AND SYSTEM FOR CONTROLLING TEMPERATURE OF MOTOR, AND STORAGE MEDIUM,” filed Nov. 6, 2023, which is incorporated by reference herein in its entirety.

### TECHNICAL FIELD

Embodiments of the present disclosure relate to the technical field of motors, and in particular, to a method and a system for controlling temperature of a motor, and a storage medium.

### BACKGROUND

As an important component in the existing implementation of tactile feedback, linear motors are widely used in electronic devices such as mobile phones, tablets, and game controllers. For different application scenarios, the types of motors used are also different. As an electromagnetic component, the main principle of the motor is based on the phenomenon of electromagnetic induction. That is, the energized coil is subjected to force in the magnetic field, and then reciprocates to produce vibration. As demands of consumers for tactile feedback devices are increasing, whether linear motors can operate stably and continuously has become the focus of research by various manufacturers. Controlling temperature of the motor is one of the most important aspects.

When the coil is continuously energized, due to the existence of wire resistance, only a small part of the energy is converted into mechanical energy, and most of the energy will be outputted through the coil in the form of thermal energy. Operating at high temperature for a long time will not only greatly reduce the service life of the motor body, but also result in damage to other hardware and even endanger users.

In a single-level temperature protection solution, the temperature threshold is set to a single value, and its corresponding voltage limiting strategy is also relatively single, resulting in an excessive impact on system performance. If the voltage is limited excessively, the system performance will be greatly affected. If the voltage is limited insufficiently, it will be difficult for the system temperature to reach a stable range in a short period of time. Therefore, the single-level temperature protection solution is difficult to meet the operating requirements of the motor driven by different voltage signals.

### SUMMARY

Embodiments of the present disclosure are intended to solve at least one of the technical problems existing in the conventional technology and provide a method and a system for controlling temperature of a motor, and a storage medium.

One aspect of the present disclosure provides a method for controlling temperature of a motor, including: acquiring a real-time temperature of the motor; comparing the real-time temperature of the motor with multiple preset temperature thresholds, where the multiple temperature thresholds correspond to a multi-level voltage amplitude limiting strategy; and determining the voltage amplitude limiting strategy at a level corresponding to the real-time temperature of the motor according to the comparison result and limiting an input voltage of the motor with the voltage amplitude limiting strategy at the level corresponding to the real-time temperature of the motor, to control the temperature of the motor.

As an improvement, determining the voltage amplitude limiting strategy at the level corresponding to the real-time temperature of the motor according to the comparison result and limiting the input voltage of the motor according to the voltage amplitude limiting strategy at the level corresponding to the real-time temperature of the motor to control the temperature of the motor includes: limiting the input voltage of the motor with the voltage amplitude limiting strategy at a lowest level according to the comparison result that the real-time temperature of the motor is higher than a lowest temperature threshold and lower than an intermediate temperature threshold; limiting the input voltage of the motor with the voltage amplitude limiting strategy at an intermediate level according to the comparison result that the real-time temperature of the motor is higher than the intermediate temperature threshold and lower than a maximum temperature threshold; and limiting the input voltage of the motor with the voltage amplitude limiting strategy at a highest level according to the comparison result that the real-time temperature of the motor is higher than the maximum temperature threshold.

As an improvement, the voltage amplitude limiting strategy includes: scaling a voltage amplitude with a scaling coefficient.

As an improvement, the scaling coefficient is a linear function with respect to time.

As an improvement, controlling the temperature of the motor has different protection modes, and the method further includes: switching between the different protection modes according to the real-time temperature of the motor.

As an improvement, the different protection modes of the motor include: a drop mode, a hold mode and a recovery mode, and switching between the different protection modes according to the real-time temperature of the motor includes: switching to the drop mode and limiting the input voltage of the motor with the voltage amplitude limiting strategy, according to the comparison result that the real-time temperature of the motor exceeds the temperature threshold; switching to the hold mode and limiting the input voltage of the motor with the voltage amplitude limiting strategy at a current level, according to the comparison result that the real-time temperature of the motor returns to a controllable range but has not reached a preset minimum temperature lower limit; and switching to the recovery mode and gradually increasing a voltage amplitude until the input voltage returns to an unrestricted state, according to the comparison result that the real-time temperature of the motor reaches the minimum temperature lower limit.

As an improvement, acquiring the real-time temperature of the motor includes: acquiring real-time thermal power inputted to the motor; and inputting the real-time thermal power to a pre-established target temperature model of the motor, and predicting the real-time temperature of the motor.

As an improvement, the target temperature model of the motor is established by: analyzing an actual physical model of the motor and external environment in which the actual physical model is used to establish an initial heat dissipation model of the motor; establishing a simulation model of the motor, and calculating initial parameters of the initial heat dissipation model according to the simulation model; and acquiring an actual voltage signal, an actual current signal and an actual temperature signal of the motor, and calibrating the initial parameters of the initial heat dissipation model based on the actual voltage signal, the actual current signal and the actual temperature signal of the motor, to obtain the target heat dissipation model of the motor.

Another aspect of the present disclosure provides a system for controlling temperature of a motor, including: an acquisition module configured to acquire a real-time temperature of the motor; a comparison module configured to compare the real-time temperature of the motor with multiple preset temperature thresholds, where the multiple temperature thresholds correspond to a multi-level voltage amplitude limiting strategy; and a limiting module configured to determine the voltage amplitude limiting strategy at a level corresponding to the real-time temperature of the motor according to the comparison result and limiting input voltage of the motor with the voltage amplitude limiting strategy at the level corresponding to the real-time temperature of the motor, to control the temperature of the motor.

Another aspect of the present disclosure provides a computer-readable storage medium on which a computer program is stored. The computer program, when executed by a processor, causes the processor to implement the method for controlling the temperature of the motor as described above.

With the method and the system for controlling the temperature of the motor as well as the storage medium according to the embodiments of the present disclosure, the temperature of the motor is controlled by limiting the input voltage. Through the multi-level temperature protection solution, when the motor reaches a certain temperature threshold, the corresponding limiting strategy comes into effect. In this way, the system can maintain better performance while limiting the operating temperature for stable operation. Therefore, the real-time temperature of the system can be effectively controlled, thereby improving user safety and extending the service life of hardware.

### BRIEF DESCRIPTION OF THE DRAWINGS

FIG. 1 is a schematic flowchart illustrating a method for controlling temperature of a motor according to an embodiment of the present disclosure;

FIG. 2 is a schematic diagram illustrating an initial heat dissipation model according to another embodiment of the present disclosure;

FIG. 3 is a schematic diagram illustrating changes in voltage amplitude according to another embodiment of the present disclosure;

FIG. 4 is a schematic diagram illustrating an input voltage and system temperature changing with time according to another embodiment of the present disclosure; and

FIG. 5 is a schematic structural diagram illustrating a system for controlling temperature of a motor according to another embodiment of the present disclosure.

### DETAILED DESCRIPTION OF THE EMBODIMENTS

The technical solutions in the embodiments of the present disclosure will be clearly and completely described below with reference to the drawings in the embodiments of the present disclosure. Obviously, the described embodiments are only some rather than all of the embodiments of the present disclosure. Based on the embodiments in the present disclosure, all other embodiments obtained by those of ordinary skill in the art without creative efforts fall within the scope of protection of the present disclosure.

Furthermore, the described features, structures or characteristics may be combined in any suitable manner in one or more embodiments. In the following description, numerous specific details are provided for a thorough understanding of embodiments of the present disclosure. However, those skilled in the art should appreciate that the technical solutions of the present disclosure may be practiced without one or more of the specific details, or other methods, components, devices, steps, etc. may be adopted. In other instances, well-known methods, devices, implementations, or operations have not been shown or described in detail to avoid obscuring aspects of the present disclosure.

The flowcharts shown in the drawings are only illustrative, and do not necessarily include all contents and operations/steps, nor the operations/steps must be performed in the order described. For example, some operations/steps may be divided, and some operations/steps may be combined or partially combined. Therefore, the order may be different based on actual conditions.

It should be understood that, although the terms first, second, third, etc. may be used herein to describe various components, these components should not be limited by these terms. These terms are used to distinguish one component from another component. Accordingly, a first component discussed below may be termed a second component without departing from the teachings of the presently disclosed concepts. As used herein, the term “and/or” includes any and all combinations of one or more of the associated listed items.

Those skilled in the art should understand that the drawings are only schematic illustrations of exemplary embodiments. The modules or processes in the drawings are not necessary to implement the present disclosure, and therefore cannot be used to limit the scope of the present disclosure.

As shown in FIG. 1, a method for controlling temperature of a motor according to an embodiment of the present disclosure includes the following operations S1 to S3.

In S1, the real-time temperature of the motor is acquired.

Specifically, with the method for controlling the temperature of the motor in this embodiment, an input voltage is controlled according to the real-time temperature of the motor. The real-time temperature of the motor may be obtained through the following operations S11 to S12.

In S11, a real-time thermal power inputted to the motor is obtained.

Specifically, the resistance R of the motor coil is known. According to the thermal power formula P=UI=I²R=U²/R, the real-time thermal power inputted to the motor can be obtained by acquiring the real-time input voltage U of the motor or the real-time input current I of the motor through a monitoring device.

In S12, the real-time thermal power is inputted into a pre-established target temperature model of the motor, and the real-time temperature of the motor is predicted.

Specifically, the target temperature model is established through the following operations S121 to S123.

In S121, an actual physical model of the motor and external environment in which the actual physical model is used are analyzed to establish an initial heat dissipation model of the motor.

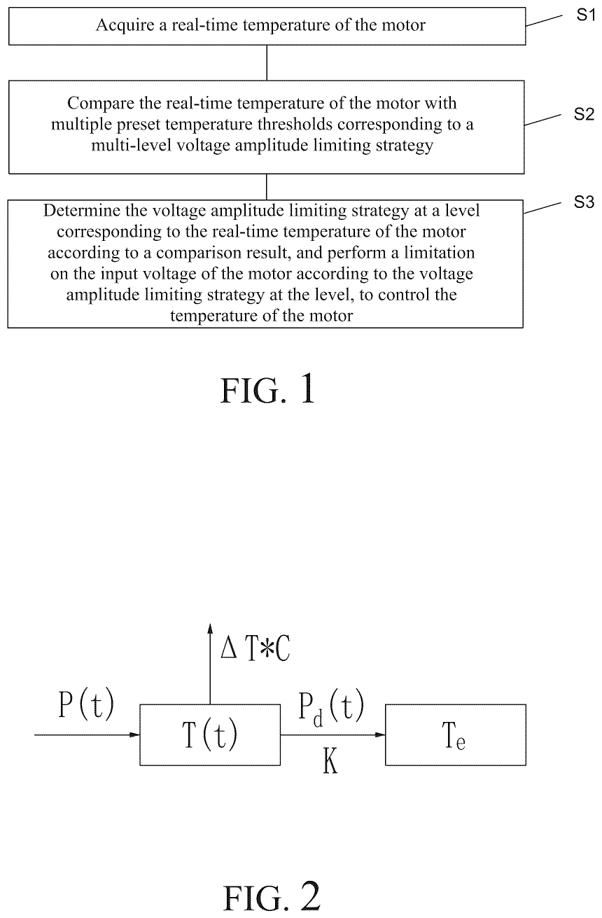

Specifically, the structure of the motor system is first analyzed. The motor realizes the function of controlling the amount of vibration by converting electrical energy into kinetic energy. The inside of the motor is mainly composed of a support frame, a coil, an iron core and a casing. The coil generates heat, which is transferred to the casing through the support frames on both sides, and then is dissipated to the environment through the casing. The heat dissipation rate depends on the structure of the system and the materials of each component. In addition to generating magnetic flux to excite the iron core, the motor coil also generates a certain amount of heat, the specific amount of resulting heat depends on the resistance of the coil per se. In practice, due to factors such as volume and cost, the instantaneous value of the internal temperature fails to be acquired in real time. Therefore, it is necessary to approximately regard the inside and outside of the motor system as a whole for transferring heat to the outside. Then the heat dissipation of the motor system is mathematically modeled. A simplified model as shown in FIG. 2, which is the initial heat dissipation model, is established. P(t) is the real-time thermal power inputted to the motor system. T(t) is the real-time temperature of the motor system. ΔT is the change in the temperature of the motor system. C is the comprehensive heat capacity. P_{d}(t) is the heat transfer power of the motor system to dissipate heat to the environment. K is the comprehensive heat transfer coefficient. Tₑ is the ambient temperature.

In S122, a simulation model is established for the motor, and initial parameters of the initial heat dissipation model are calculated according to the simulation model.

Specifically, finite element simulation is used to model the system. The accurate values of each parameter in the initial heat dissipation model are determined based on the specific structure and material properties of the motor in the actual situation.

In S123, an actual voltage signal, an actual current signal and an actual temperature signal of the motor are acquired. The initial parameters of the initial heat dissipation model are calibrated based on the actual voltage signal, the actual current signal and the actual temperature signal of the motor, to obtain the target heat dissipation model of the motor.

Specifically, in order to further verify the accuracy of the model parameters in conjunction with reality, the actual voltage and current signals are first collected, and then the actual temperature is estimated through the resistance temperature measurement method, and the initial heat dissipation model is calibrated to obtain the more accurate target heat dissipation model.

After calibrating the model parameters with the above-mentioned actual sampling signals, the temperature at each moment can be accurately predicted based on the real-time thermal power inputted to the motor system.

In S2, the real-time temperature of the motor is compared with multiple preset temperature thresholds. The multiple temperature thresholds corresponding to a multi-level voltage amplitude limiting strategy.

Specifically, it can be seen from the above operations that the main heat source of the motor system comes from the coil, and the excitation source of the coil mainly comes from the input voltage. By limiting the amplitude of the voltage signal to a certain extent, the heating power can be controlled, thereby reducing the temperature of the system. The target thermal model can calculate the real-time temperature of the coil of the motor. By setting the temperature threshold and changing the input voltage in real time, the temperature of the motor can be controlled in real time.

In order to ensure the dynamic performance of the system, multiple different temperature thresholds set in this embodiment correspond to multiple levels of temperature limits. The temperature threshold is divided into several levels from small to large. When the temperature is at a lower threshold, the system is operating at slightly high temperature but still within the allowable range, and operating in the current state will not affect the hardware. A gentler approach should be taken to limit the amplitude of the voltage accordingly. When the temperature is at the intermediate threshold, the system is operating at relatively high temperature and is not suitable to operate in the current state for a long time. In this case, a more radical restriction strategy is adopted to control the temperature within a reliable range in a short period of time. When the temperature reaches the set maximum threshold, the current temperature has reached the maximum allowable temperature of the system. In this case, the system is operating in a more dangerous state, and the voltage is to be cut off in a short period of time to ensure that the temperature no longer rises and to ensure the safety of users.

In S3, the voltage amplitude limiting strategy at a level corresponding to the real-time temperature of the motor is determined according to the comparison result. The input voltage of the motor is limited according to the voltage amplitude limiting strategy at the level corresponding to the real-time temperature of the motor, to control the temperature of the motor.

For example, temperature protection of three levels is set. If the real-time temperature of the motor is higher than the lowest temperature threshold and lower than the intermediate temperature threshold, the voltage amplitude limiting strategy at the lowest level is used to limit the input voltage of the motor. If the real-time temperature of the motor is higher than the intermediate temperature threshold and lower than the maximum temperature threshold, the voltage amplitude limiting strategy at the intermediate level is used to limit the input voltage of the motor. If the real-time temperature of the motor is higher than the maximum temperature threshold, the voltage amplitude limiting strategy at the highest level is used to limit the input voltage of the motor.

Exemplarily, the voltage amplitude limiting strategy includes scaling the voltage amplitude with a scaling coefficient.

Specifically, in order to ensure that the signal is not distorted and meets the requirements of smoothness and stability, the voltage is scaled as a whole. The scaling coefficient is a variable coefficient (called as SCALE), which ranges from 0 to 1. By adjusting SCALE, the voltage amplitude can be scaled while keeping the shape of the original signal unchanged.

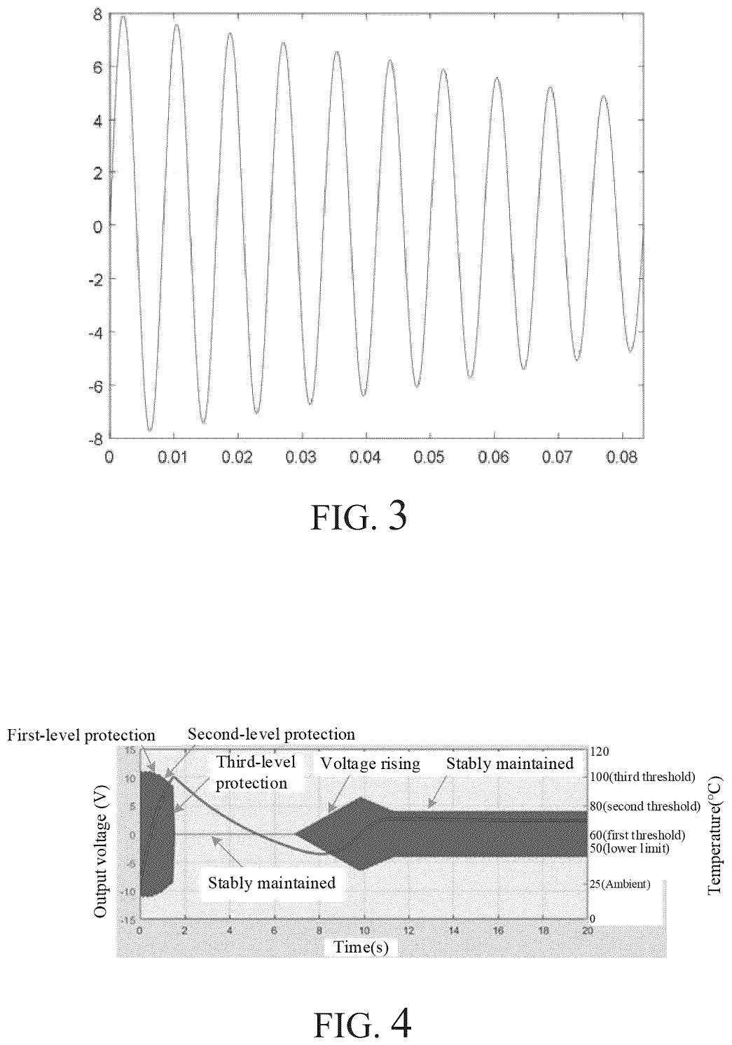

Further, in order to gradually scale the voltage, the scaling coefficient SCALE is set as a linear function with respect to time. The scaling coefficient SCALE gradually decreases with time, and the voltage amplitude also changes linearly. Under voltage amplitude limiting strategies at different levels, different dropping slopes are set to ensure that the voltage amplitude can drop at different rates to control the temperature in real time. For details about the changes in the voltage amplitude, reference is made to FIG. 3.

The voltage amplitude is controlled using the gradient scaling coefficient SCALE. When the system temperature reaches the minimum temperature threshold, the system temperature is relatively high. In this case, a certain voltage limiting strategy is to be adopted to control the voltage to decrease with a smaller slope. When the predicted system temperature continues to rise and reaches the intermediate temperature threshold, the limiting level presently adopted is too low to prevent the system temperature from rising. In this case, the voltage drop rate is to be increased to prevent the system temperature from rising. When the system temperature rises to the maximum temperature threshold, the system is at a more dangerous temperature. In this case, the voltage signal should be cut off in a short period of time. Based on the scale coefficient presently used, the rate at which the voltage drops to 0 within a fixed period of time (the specific time parameter setting is subject to the actual situation) is calculated to ensure that the system temperature does not exceed the safe range.

Exemplarily, controlling temperature of the motor has different protection modes. The method further includes: switching between the different protection modes according to the real-time temperature of the motor.

Specifically, the different protection modes of the motor include: a drop mode, a hold mode and a recovery mode. Switching between the different protection modes according to the real-time temperature of the motor includes: switching to the drop mode and limiting the input voltage of the motor with the voltage amplitude limiting strategy, according to the comparison result that the real-time temperature of the motor exceeds the temperature threshold; switching to the hold mode and limiting the input voltage of the motor with the voltage amplitude limiting strategy at the level presently adopted, according to the comparison result that the real-time temperature of the motor returns to the controllable range but has not reached a preset minimum temperature lower limit; and switching to the recovery mode to gradually increase a voltage amplitude until the input voltage returns to an unrestricted state, according to the comparison result that the real-time temperature of the motor reaches the minimum temperature lower limit.

That is, in the drop mode, the voltage amplitude limiting strategy in any of the above embodiments is used to control the motor temperature to ensure safe operation. In the hold mode, when the system is in any state, if the system temperature returns to the controllable range but has not yet reached the minimum temperature lower limit, the current limit amplitude should be maintained to ensure that the temperature is in a stable range to stabilize the system state and maintain a declining state. Based on the above mode, the temperature continues to decrease. When the system temperature reaches the lowest temperature lower limit, the system switches to the recovery mode. In the recovery mode, the voltage is gradually raised according to the limiting level presently adopted until the system temperature exceeds the threshold again or the voltage returns to the maximum of the original input to ensure system performance. When the temperature is within a reliable range, the limiting on the voltage is gradually cancelled.

For example, there are three temperature thresholds of 60° C., 80° C., and 100° C. The changes in the input voltage and the system temperature over time are shown in FIG. 4. By default, the system starts in a completely cooled state. The current motor temperature is equal to the ambient temperature, which is 25° C. During the startup phase, the voltage is inputted at full amplitude without limitation. When the system temperature reaches the first threshold (60° C.), the system triggers the first level of temperature protection, and the voltage continues to decrease at a rate of first level. After the first-level temperature protection is triggered, the system temperature is still rising and reaches the second threshold (80° C.) in a short period of time. The system triggers the second-level temperature protection, and the voltage signal continues to decrease at a faster rate. The system temperature continues to rise and reaches the third threshold (100° C.). The protection module cuts off the voltage in a short period of time and maintain it for a period of time until the temperature drops to a safe range. After a period of time, the system temperature no longer rises, that is, the limiting level presently adopted can meet the needs of temperature protection. The limiting level presently adopted is maintained and the temperature drops. When the system temperature drops to the lower temperature limit, the temperature has reached a safe range, and the voltage can be gradually increased. During the recovery, the temperature rises again. When the temperature exceeds the first threshold for the second time, the system triggers the first-level temperature protection again. During the second descent, when the system determines that the temperature is no longer rising, the limiting level presently adopted is maintained. In this case, the temperature can be maintained within a safe range, and the system operates stably while the input voltage amplitude remains unchanged.

With the method for controlling the temperature of the motor according to embodiments of the present disclosure, the temperature of the motor is controlled by limiting the input voltage. Through the multi-level temperature protection solution, when the motor reaches a certain temperature threshold, the corresponding limiting strategy comes into effect. In this way, the system can maintain better performance while limiting the operating temperature for stable operation. Therefore, the real-time temperature of the system can be effectively controlled, thereby improving user safety and extending the service life of hardware.

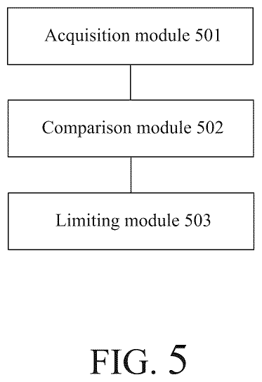

As shown in FIG. 5, a system for controlling temperature of a motor according to another embodiment of the present disclosure includes: an acquisition module 501, a comparison module 502 and a limit module 503. The acquisition module 501 is configured to acquire a real-time temperature of the motor. The comparison module 502 is configured to compare the real-time temperature of the motor with multiple preset temperature thresholds. The multiple temperature thresholds correspond to a multi-level voltage amplitude limiting strategy. The limiting module 503 is configured to determine the voltage amplitude limiting strategy at a level corresponding to the real-time temperature of the motor according to the comparison result and limiting input voltage of the motor with the voltage amplitude limiting strategy at the level corresponding to the real-time temperature of the motor to control the temperature of the motor.

The system for controlling temperature of the motor in this embodiment is configured to perform the method for controlling temperature of the motor as described above, and therefore is not detailed herein.

A computer-readable storage medium is provided according to another embodiment of the present disclosure. The computer program, when executed by a processor, causes the processor to implement the method for controlling the temperature of the motor as described above.

The computer-readable medium may be included in the system according to the present disclosure or may exist separately.

The computer-readable storage medium may be any tangible medium that contains or stores programs, such as electronic, magnetic, optical, electromagnetic, infrared, and semiconductor systems, devices, and apparatuses. More specific examples of the computer readable storage medium include, but are not limited to: electrical connections having one or more wires, portable computer disks, hard drives, fiber optics, a random access memory (RAM), a read only memory (ROM), an erasable programmable read-only memory (EPROM or flash memory), a portable compact disk read-only memory (CD-ROM), optical storage devices, magnetic storage devices, or any suitable combination thereof.

The computer-readable storage medium may also include a data signal propagated in baseband or as part of a carrier wave carrying computer-readable program code therein. Specific examples of the computer-readable storage medium include, but are not limited to, electromagnetic signals, optical signals, or any suitable combination thereof.

It should be understood that the above embodiments are merely exemplary embodiments adopted for illustrating the principles of the present disclosure. However, the present disclosure is not limited thereto. For those of ordinary skill in the art, various modifications and improvements can be made without departing from the spirit and essence of the present disclosure. These modifications and improvements are also regarded as the protection scope of the present disclosure.

What is claimed is:

1. A method for controlling temperature of a motor, comprising:
acquiring a real-time temperature of the motor;
comparing the real-time temperature of the motor with a plurality of preset temperature thresholds, wherein the plurality of the temperature thresholds correspond to a multi-level voltage amplitude limiting strategy; and
determining a voltage amplitude limiting strategy at a level corresponding to the real-time temperature of the motor according to a comparison result and limiting an input voltage of the motor with the voltage amplitude limiting strategy at the level corresponding to the real-time temperature of the motor, to control the temperature of the motor.

2. The method according to claim 1, wherein determining the voltage amplitude limiting strategy at the level corresponding to the real-time temperature of the motor according to the comparison result and limiting the input voltage of the motor according to the voltage amplitude limiting strategy at the level corresponding to the real-time temperature of the motor to control the temperature of the motor comprises:
limiting the input voltage of the motor with the voltage amplitude limiting strategy at a lowest level according to the comparison result that the real-time temperature of the motor is higher than a lowest temperature threshold and lower than an intermediate temperature threshold;
limiting the input voltage of the motor with the voltage amplitude limiting strategy at an intermediate level according to the comparison result that the real-time temperature of the motor is higher than the intermediate temperature threshold and lower than a maximum temperature threshold; and
limiting the input voltage of the motor with the voltage amplitude limiting strategy at a highest level according to the comparison result that the real-time temperature of the motor is higher than the maximum temperature threshold.

3. The method according to claim 1, wherein the voltage amplitude limiting strategy comprises: scaling a voltage amplitude with a scaling coefficient.

4. The method according to claim 3, wherein the scaling coefficient is a linear function with respect to time.

5. The method according to claim 1, wherein controlling the temperature of the motor has different protection modes, and the method further comprises:
switching between the different protection modes according to the real-time temperature of the motor.

6. The method according to claim 5, wherein the different protection modes of the motor comprise: a drop mode, a hold mode and a recovery mode, and the switching between the different protection modes according to the real-time temperature of the motor comprises:
switching to the drop mode and limiting the input voltage of the motor with the voltage amplitude limiting strategy, according to the comparison result that the real-time temperature of the motor exceeds the temperature threshold;
switching to the hold mode and limiting the input voltage of the motor with the voltage amplitude limiting strategy at a current level, according to the comparison result that the real-time temperature of the motor returns to a controllable range but has not reached a preset minimum temperature lower limit; and
switching to the recovery mode and gradually increasing a voltage amplitude until the input voltage returns to an unrestricted state, according to the comparison result that the real-time temperature of the motor reaches the minimum temperature lower limit.

7. The method according to claim 1, wherein acquiring the real-time temperature of the motor comprises:
acquiring real-time thermal power inputted to the motor; and
inputting the real-time thermal power to a pre-established target temperature model of the motor, and predicting the real-time temperature of the motor.

8. The method according to claim 7, wherein the target temperature model of the motor is established by:
analyzing an actual physical model of the motor and external environment in which the actual physical model is used, to establish an initial heat dissipation model of the motor;
establishing a simulation model for the motor, and calculating initial parameters of the initial heat dissipation model according to the simulation model; and
acquiring an actual voltage signal, an actual current signal and an actual temperature signal of the motor, and calibrating the initial parameters of the initial heat dissipation model based on the actual voltage signal, the actual current signal and the actual temperature signal of the motor, to obtain the target heat dissipation model of the motor.

9. A system for controlling temperature of a motor, comprising at least one processor and a storage medium, wherein the storage medium stores:
an acquisition module configured to acquire a real-time temperature of the motor;
a comparison module configured to compare the real-time temperature of the motor with a plurality of preset temperature thresholds, wherein the plurality of the temperature thresholds correspond to a multi-level voltage amplitude limiting strategy; and
a limiting module configured to determine the voltage amplitude limiting strategy at a level corresponding to the real-time temperature of the motor according to the comparison result and limiting an input voltage of the motor with the voltage amplitude limiting strategy at the level corresponding to the real-time temperature of the motor to control the temperature of the motor.

10. A non-transitory computer-readable storage medium, storing a computer program, wherein the computer program, when executed by a processor, causes the processor to implement a method for controlling temperature of a motor, wherein the method comprises:
acquiring a real-time temperature of the motor;
comparing the real-time temperature of the motor with a plurality of preset temperature thresholds, wherein the plurality of the temperature thresholds correspond to a multi-level voltage amplitude limiting strategy; and
determining the voltage amplitude limiting strategy at a level corresponding to the real-time temperature of the motor according to a comparison result and limiting an input voltage of the motor with the voltage amplitude limiting strategy at the level corresponding to the real-time temperature of the motor to control the temperature of the motor.

11. The method according to claim 2, wherein controlling the temperature of the motor has different protection modes, and the method further comprises:
switching between the different protection modes according to the real-time temperature of the motor.

12. The method according to claim 3, wherein controlling the temperature of the motor has different protection modes, and the method further comprises:
switching between the different protection modes according to the real-time temperature of the motor.

13. The method according to claim 4, wherein controlling the temperature of the motor has different protection modes, and the method further comprises:
switching between the different protection modes according to the real-time temperature of the motor.

14. The method according to claim 2, wherein acquiring the real-time temperature of the motor comprises:
acquiring real-time thermal power inputted to the motor; and
inputting the real-time thermal power to a pre-established target temperature model of the motor, and predicting the real-time temperature of the motor.

15. The method according to claim 3, wherein acquiring the real-time temperature of the motor comprises:
acquiring real-time thermal power inputted to the motor; and
inputting the real-time thermal power to a pre-established target temperature model of the motor, and predicting the real-time temperature of the motor.

16. The method according to claim 4, wherein acquiring the real-time temperature of the motor comprises:
acquiring real-time thermal power inputted to the motor; and
inputting the real-time thermal power to a pre-established target temperature model of the motor, and predicting the real-time temperature of the motor.
